(19) United States
(12) Patent Application Publication
(10) Pub. No.: US 2026/0258790 A1
(43) Pub. Date: Sep. 3, 2026

(54) WIND TURBINE GEARBOX WITH MULTIPLE GENERATORS AND SPECIFIC GEAR RATIOS

(71) Applicant: VINDG A/S, Vedbaek (DK)

(72) Inventor: Troels Pedersen, Gilleleje (DK)

(73) Assignee: VINDG A/S, Vedbaek (DK)

(21) Appl. No.: 19/161,605

(22) PCT Filed: Mar. 1, 2024
(86) PCT No.: PCT/EP2024/055412

§ 371 Date: Sep. 2, 2025

(30) Foreign Application Priority Data
Mar. 2, 2023 (EP) 23159628.9

(51) Int. Cl. F03D 15/10; F03D 9/25; H02K 7/116; H02K 7/18

(52) U.S. Cl. CPC F03D 15/101; F03D 9/25; H02K 7/116; H02K 7/1838; F05B 2260/40311

(57) ABSTRACT

A wind turbine gearbox is disclosed for transmitting a wind generated rotary input to multiple electrical generators. The gearbox includes a first gearbox stage with a first bull gear and at least five first pinion gears. The first bull gear receives the wind generated rotary input and the pinion gears mesh with the first bull gear to generate at least five first rotary outputs. The first output shafts, fixed relative to the pinion gears and suspended in plain bearings, transmit the first rotary outputs to the electrical generators via a second gearbox stage. The first gearbox stage has a gear ratio of 5:1 or more, and the second gearbox stage has a gear ratio equal to or less than that of the first gearbox stage gear ratio.

### FIELD OF INVENTION

The present disclosure generally pertains to the field of wind energy conversion, and more specifically, to wind turbine gearboxes designed for transmitting wind-generated rotary input to multiple electrical generators with specific gear ratios.

### BACKGROUND

Wind turbines are mechanical devices that convert wind energy into electrical energy. They have been globally adopted as a source of renewable green energy. A typical wind turbine comprises a tower, turbine blades, a nacelle, and a drivetrain. The tower is generally vertical and its height can vary as per requirements. Turbine blades are located around a pivot towards the upper end of the tower and are rotated by wind energy. This wind-generated mechanical energy is transmitted to a nacelle for conversion to electrical energy.

The nacelle typically comprises an enclosed housing for housing one or more generators, a gearbox, drivetrain, and brake assembly. The gearbox is a central component of the wind turbine, responsible for transmitting the wind-generated rotary input to the electrical generators. It does so by increasing the rotational speed of the turbine rotor to a level suitable for the generators. This is achieved through a series of gear stages, each comprising a set of gears with specific gear ratios.

The design of a gearbox is influenced by many factors such as mass, size, use of materials, and gear alignment. A greater mass is more difficult and expensive to lift into position towards the upper end of a tall tower. Size influences mass and usage of materials. Materials vary in cost and availability. Additional factors such as axial and radial gear alignment may also be considered in the design of bearings for the gears.

Reliability is of great concern, especially for large wind turbines positioned off-shore, as they are costly to maintain and repair. Therefore, the design and configuration of the gearbox play a pivotal role in the overall performance and reliability of the wind turbine.

### SUMMARY OF INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to a first aspect of the present disclosure, a wind turbine gearbox is provided for transmitting a wind generated rotary input to five or more electrical generators for generating electrical energy in a wind turbine. The wind turbine gearbox includes at least a first gearbox stage. This first gearbox stage comprises a first bull gear for receiving the wind generated rotary input and at least five first pinion gears that mesh with the first bull gear for receiving the wind generated rotary input and generating at least five first rotary outputs. The gearbox also includes respective first output shafts fixed relative to the first pinion gears and suspended in plain bearings for rotation. These first output shafts transmit the first rotary outputs to the five or more electrical generators via a second gearbox stage. In this configuration, the first gearbox stage has a gear ratio of 5:1 or more, and the second gearbox stage has a gear ratio equal to or less than that of the first gearbox stage gear ratio.

According to a second aspect of the present disclosure, the gear ratio of the second stage may be less than or equal to 50% of the gear ratio of the first stage. This configuration allows for a more efficient transmission of the wind generated rotary input to the electrical generators.

In a third aspect of the present disclosure, the plain bearings of the first output shafts may be of a hydrodynamic type. This type of bearing provides a smooth and efficient rotation of the output shafts, reducing friction and wear, and thereby increasing the lifespan and reliability of the gearbox. In addition, the total volume, mass and cost of the gearbox is reduced.

According to a fourth aspect of the present disclosure, the first gearbox stage may have a meshing teeth pattern that reduces the axial forces during load to less than 10% of the meshing forces acting during load. This configuration reduces the strain on the gearbox components, further enhancing the reliability and lifespan of the gearbox.

In a fifth aspect of the present disclosure, the second gearbox stage may comprise a planetary gear type. This type of gear arrangement provides a compact and efficient transmission of the rotary input to the electrical generators.

According to a sixth aspect of the present disclosure, the first bull gear of the first gearbox stage may be connected directly to a carrier of the rotational input, a wind turbine main shaft, or a wind turbine rotor. This direct connection allows for a more efficient transmission of the wind generated rotary input to the gearbox.

In a seventh aspect of the present disclosure, the pinion shafts of any of the first to third gearbox stages may be connected to an oil pump. This configuration provides a continuous supply of lubrication to the gearbox components, reducing friction and wear, and thereby increasing the lifespan and reliability of the gearbox.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 provides a schematic representation of a wind turbine gearbox, illustrating the transmission of wind-generated rotary input to electrical generators.

FIG. 2 depicts another example of a wind turbine gearbox, showcasing a different arrangement of gears and the flow of mechanical energy.

FIG. 3 presents a schematic representation of a wind turbine gearbox system, emphasizing the flow of mechanical energy from the input shaft through the gearbox stages to the generator.

FIG. 4 displays a table illustrating the relationship between the gear ratio, the number of pinions, and the equivalent number of planets in a planetary gearbox.

FIG. 5 shows a graph illustrating the development in mass per kilonewton-meter as a function of power rating for wind turbine gearboxes.

FIGS. 6 and 7 present graphs related to a wind turbine gearbox, showing the relationship between the second stage mass of a gearbox and the total gear ratio for different first stage gear ratios, and comparing the relative mass of gearwheels for different gearbox configurations, respectively.

FIG. 8 depicts a schematic representation of a wind turbine gearbox component, illustrating the mechanical connections and lubrication system within the gearbox.

FIG. 9 presents a comparison of failure risks for different wind turbine gearbox configurations over a 20-year perspective.

FIG. 10 provides a side view of a wind turbine, showcasing the placement of the gearbox within the nacelle and the flow of wind that the turbine blades harness to generate energy.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure pertains to a wind turbine gearbox designed to transmit a wind-generated rotary input to multiple electrical generators, thereby converting wind energy into electrical energy. This gearbox is particularly suited for use in a wind turbine and includes at least a first and a second gearbox stage.

In some aspects, the first gearbox stage of the wind turbine gearbox comprises a first bull gear that receives the wind-generated rotary input. This stage also includes at least five first pinion gears that mesh with the first bull gear, receiving the wind-generated rotary input and generating at least five first rotary outputs. These outputs are transmitted to the electrical generators via respective first output shafts, which are fixed relative to the first pinion gears and suspended in plain bearings for rotation. The first gearbox stage is characterized by a gear ratio of 5:1 or more.

In other aspects, the second gearbox stage of the wind turbine gearbox has a gear ratio that is equal to or less than that of the first gearbox stage. This configuration allows for efficient transmission of the rotary outputs from the first stage to the electrical generators, facilitating the conversion of wind energy into electrical energy.

The wind turbine gearbox disclosed herein offers several potential benefits. For instance, the use of plain bearings in the suspension of the first output shafts may enhance the durability and reliability of the gearbox. Additionally, the specific gear ratios of the first and second gearbox stages may optimize the transmission of wind-generated rotary input to the electrical generators, potentially improving the efficiency of energy conversion. Furthermore, the design of the wind turbine gearbox may allow for flexibility in the configuration of the second gearbox stage, which could include a variety of gear types such as planetary gear type, thereby offering adaptability to different wind turbine designs and operational conditions.

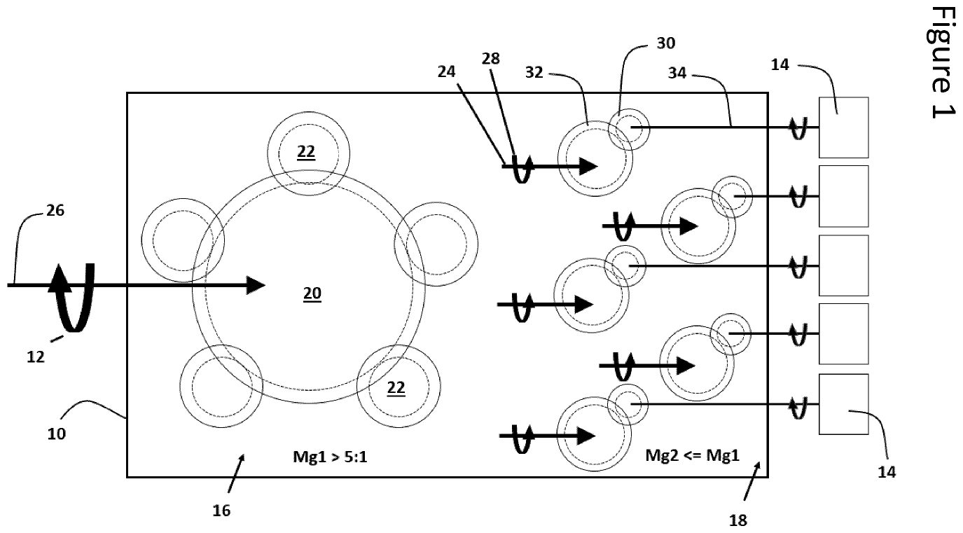

Referring to FIG. 1, a schematic representation of a wind turbine gearbox 10 is depicted. The gearbox 10 is designed to transmit a wind generated rotary input 12 to five or more electrical generators 14 for generating electrical energy in a wind turbine. The wind generated rotary input 12 is received by a first bull gear 20 through an input shaft 26. In some aspects, the first bull gear 20 of the first gearbox stage may be connected directly to a carrier of the rotational input, a wind turbine main shaft, or a wind turbine rotor.

The first bull gear 20 meshes with at least five first pinion gears, generating at least five first rotary outputs 28. These first rotary outputs are transmitted via first output shafts 24 to a second gearbox stage 18. In some cases, the first gearbox stage may have a meshing teeth pattern that reduces the axial forces during load to less than 10% of the meshing forces acting during load. This configuration may enhance the efficiency and reliability of the gearbox operation.

In the second gearbox stage 18, the first rotary outputs engage with second pinion gears 30 that mesh with a second bull gear 32. The second bull gear 32 then transmits the rotary motion to second output shafts 34, which are connected to the electrical generators 14 for generating electrical energy.

The second gearbox stage 18 may comprise any one or more gearbox type arrangements, such as a simple pinion/drive gear configuration as shown, a planetary gear, or a split gear arrangement comprising an input gear.

The second gearbox stage 18 has a gear ratio equal or less than that of the first gearbox stage 16 gear ratio (Mg2<=Mg1).

The plurality of gear arrangements of the second gearbox stage 18 as shown comprises respective single second inputs (first outputs) to a second bull gear 32 that drives a plurality of second pinion gears 30. A single second rotary output is transmitted from each gear arrangement to an output shaft 34.

There is considerable choice when designing the second gearbox stage 18. For example, one or more gear arrangements may be selected or deselected for rotation, for instance depending on wind conditions.

One gear arrangement may be of one type and another gear arrangement may be of different type. One gear arrangement may have a gear ratio that is different to the gear ratio of another gear arrangement, thus second output shafts does not rotate with same speed during operation.

With regards to these differences, it may be the case that under light wind conditions compared to strong wind conditions a particular type of a gear arrangement is preferred or the number of generators that are driven, or speed, power or torque required may change.

Just to serve as an example, during low winds only one generator may be in operation for creating energy, said also comprising a higher gear ratio, than other second stage gearboxes. During high winds and when the rotary input speed 12 is high, all generators may be enrolled in producing power.

Still further the number of gearbox stages may be three or more, particularly where the total gear ratio of all stages is required to be large, for example 40:1. In such an example, the first gear box stage may be, say, 8:1 the second and third gearbox stages may be, say, 2.5:1 in order to multiply to a total ratio of 40:1. The second and third or further gear ratios may be different one from another.

In some embodiments, the generators 14 are AC generators having either a field winding or a permanent magnet. An electrically conductive coil may be located in the magnetic field, facilitating the conversion of the mechanical energy into electrical energy. This configuration allows for efficient energy conversion and adaptability to different wind turbine designs and operational conditions.

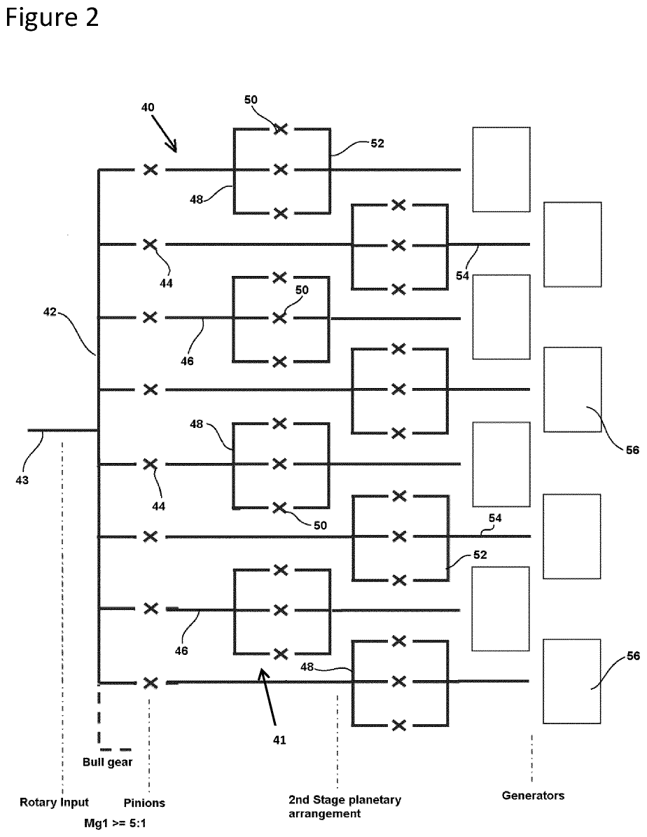

Turning to FIG. 2, a schematic representation of a wind turbine gearbox 40 is depicted. In this configuration, a bull gear 42 receives a rotary input 43 and meshes with multiple pinion gears 44. Each pinion gear 44 is connected to a first rotary output shaft 46, which in turn is associated with a planetary holder 48. Planetary gears 50 mesh with the planetary holder 48 and an annulus ring gear 52 to drive second rotary output shafts 54. These shafts 54 are connected to generators 56, which convert the mechanical energy into electrical energy. This arrangement illustrates the flow of mechanical energy from the rotary input 43 through the gearbox stages to the electrical generators 56, with a gear ratio of the first stage being 5:1 or more.

In some aspects, the gear ratio of the second stage may be less than or equal to 50% of the gear ratio of the first stage. This configuration may optimize the transmission of the rotary outputs from the first stage to the electrical generators, potentially improving the efficiency of energy conversion.

In some cases, the second gearbox stage may comprise a planetary gear type. This configuration may offer advantages in terms of compactness and efficiency, potentially enhancing the performance of the wind turbine gearbox. The second gear arrangements 41 each comprise a planetary holder 48 receiving the input torque from the first rotary output shaft 46, and which planetary arrangement also comprises a number of planets 50. This configuration may allow for efficient transmission of the rotary outputs from the first stage to the electrical generators.

In some embodiments, the first bull gear 42 and the first pinion gears 44 may have a meshing teeth pattern that reduces the axial forces during load to less than 10% of the meshing forces acting during load. This configuration may enhance the efficiency and reliability of the gearbox operation. In some cases, the teeth of the drive gear and driven gear may be helical rather than spur and may be double helical, e.g., herringbone. This configuration may offer advantages in terms of noise reduction and axial stability.

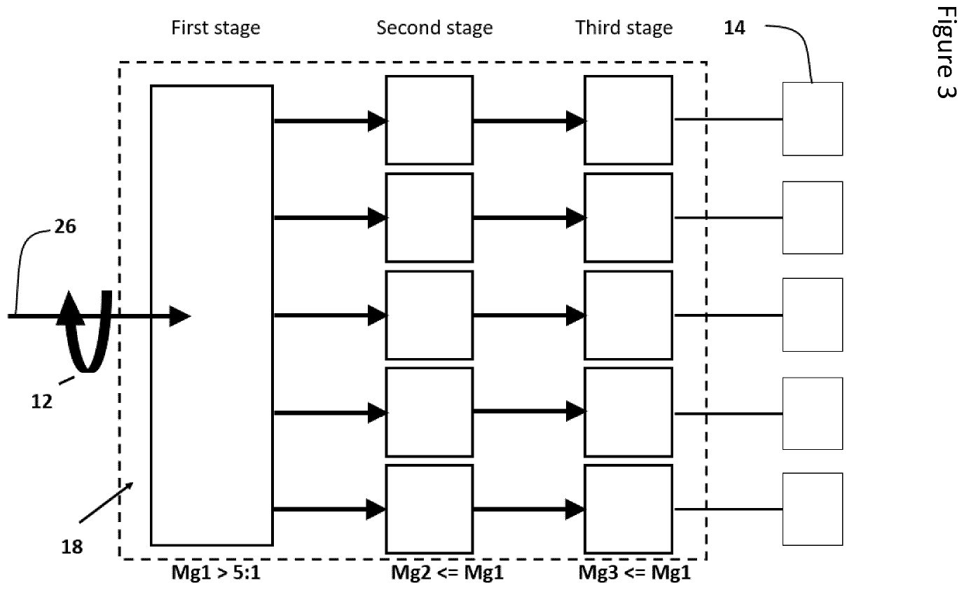

Referring now to FIG. 3, a schematic representation of a wind turbine gearbox system is depicted. In this configuration, an input shaft 26 receives an input speed 12, which is then transmitted through a first gearbox stage 18 to a second gearbox stage. The input speed 12 may be generated by the rotation of wind turbine blades (not shown in the figure) and transmitted to the input shaft 26. The input shaft 26, in turn, transfers this wind-generated rotary input to the first gearbox stage 18, which may be similar to the first gearbox stage described in relation to FIG. 1 or 2.

In some aspects, the first gearbox stage 18 may comprise a first bull gear (not shown in the figure) that meshes with at least five first pinion gears (not shown in the figure) to generate at least five first rotary outputs. These first rotary outputs are then transmitted to the second gearbox stage. The second gearbox stage may comprise a second bull gear and second pinion gears (not shown in the figure) that mesh with the second bull gear to generate second rotary outputs.

FIG. 3 differs from FIG. 2 in that subsequent to the first stage there are two further stages. The further stages have gear ratios Mg2<=Mg1 and Mg3<=Mg1 (and MgN<=Mg1, where ‘N’ is any integer number that can practically be used in a wind turbine gearbox). Any type of gear arrangement may be adopted for the further stages or different types of stages and different gear ratios may be used, one from another.

In the embodiments illustrated in FIG. 1 to 3, each gearbox is discrete, or separate, from its associated generators. In other examples, the second gear box stage or the last gearbox stage or stages is/are integral with the generators, thereby providing a gear arrangement and generator subassembly or assemblies. The subassembly is discrete from the first gearbox stage and may be housed separately.

The generators 14 are connected to the third gearbox stage and are configured to convert the mechanical energy received from the third gearbox stage into electrical energy. In some aspects, the generators 14 may be AC generators having either a field winding or a permanent magnet. The generators 14 may be configured to generate electrical energy at a desired voltage and frequency, which may be suitable for transmission to an electrical grid or for use in a localized electrical system.

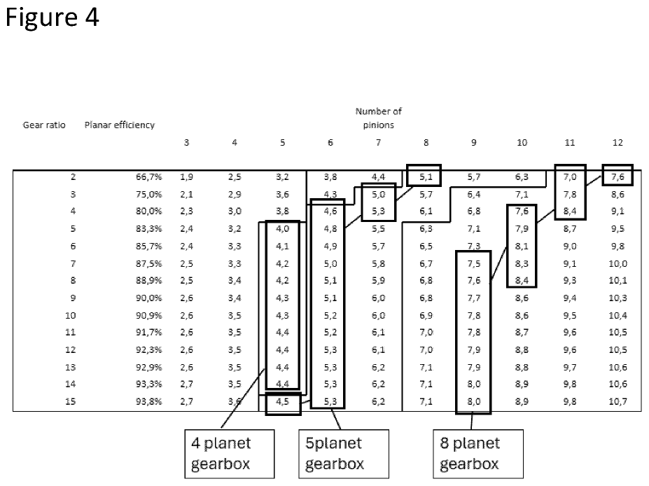

Turning to FIG. 4, a table is depicted, illustrating the relationship between the gear ratio, the number of pinions, and the equivalent number of planets in a planetary gearbox. The table shows a range of gear ratios from 2:1 to 15:1 on the vertical axis and the number of pinions from 3 to 12 on the horizontal axis. Each cell within the table represents a combination of a specific gear ratio and number of pinions, with the corresponding equivalent number of planets in a planetary gearbox indicated within the cell.

FIG. 4 illustrates in tabular form embodiments comprising first stage gearboxes with different numbers of planets, or pinions. Gear ratio, number of pinions and planar efficiency (percentage meshing) are shown. The numbers in the scheme represent an overview illustrating what will be an equivalent in number of planets in a planetary gearbox. Thus, 5 pinions and 6:1 in gear ratio is equivalent to a first stage 4 planet planetary gearbox, when considering load sharing. As seen the highest number of equivalent planetary gearbox is when using 12 pinions and 15:1 in gear ratio which would require almost 11 planets in planetary gearbox to be equivalent load distribution.

For a planetary gearbox, the meshing per planet gear wheel is typically two teeth per planet wheel, though the distance from the center of the planet carrier to the center of the planet wheels is considered for determining the forces acting during meshing. This distance is shorter than half of the outer diameter of the annulus ring gear, which is considered a drawback for known planetary gearboxes.

Further, the known planetary solution is not considered fully effective with respect to sharing efficiency. When e. g using eight planets in the system only 80% meshing is considered, meaning—on average—only 6,4 planet meshing are actually transferring and sharing load, whereas the rest of the planets are not considered participating, due to imperfections in meshing from production tolerances. In practice all eight planetary gear wheels may be meshing with the annulus ring gear and the sun gear, though some may not share maximum force, which consequently reduces the efficacy of the planetary gear system.

In embodiments of the invention disclosed, effectiveness in meshing may be set to 95% per meshing, to compensate for lack of equal load from generators. Even when comparing embodiments of the invention to newer larger size planetary gearboxes used in wind turbines where up to eight planet wheels are used, the high number of planets reduce the gear ratio of the planet gearbox significantly, forcing a higher weight or mass of material for a following second or even third gear stage. For example, a known planet gearbox comprising five planets may limit the gear ratio to 4,5:1 in the first stage. Using eight planets lowers the maximum gear ratio of the first stage to maximum 3:1, which increases the need for dimensioning of the following planetary gear stage or stages, increasing mass of gear wheels and in particular complexity and reliability in general.

In embodiments of the invention, when using five meshing pinions and minimal 5:1 gear ratio, utilization of the available space for the gear system is better than a known planetary gear. As one aim of the embodiments is to reduce the overall mass consumption of high-grade steel and the corresponding complex processing in manufacturing/processing of the gearbox, considering that the gearbox total gear ratio reduces the size and cost of the generator-a single stage cannot be considered solely. When trying to reach a higher total gear ratio, embodiments require further stages such as a second or a third gear stage to increase speed, by which the generator is reduced in size and cost.

An alternative to the embodiments of the invention is to increase the size of the planetary gearbox to compensate for fewer planets and enabling higher gear ratio in each step. This is a costly simplification, as the total amount of material consumption increases together with manufacturing equipment and handling equipment.

Embodiments of the invention provide a much higher gear ratio in the first stage (5:1 or more), thus making a second stage less demanding with respect to handling torque. In particular, the usage of multiple pinions helps to reduce the torque significantly, as the usage of eight pinions with 8:1 ratio in each reduces the input torque for the second stage by a factor of 64. The drawback is that eight individual second stage gearbox arrangements must be provided instead of a single one, increasing the number of parts.

Even though it may not be considerable to prefer a distribution between first stage gear ratio and second stage gear ratio, it has been found that the overall best utilization of high grade steel is found when ensuring that the second stage has a gear ratio equal or less than that of the first stage (Mg2<=Mg1).

In order to further improve the benefit of embodiments of the invention, the second gear stage ratio, may be reduced to equal to half or less of that of the first stage (Mg2<=50%Mg1), which improves the utilization of the costly materials further.

In some aspects, the first gearbox stage of the wind turbine gearbox 40 may comprise between, and including, five and twelve pinions. This configuration may allow for a more efficient distribution of the wind-generated rotary input 12 across multiple pinions, potentially enhancing the performance of the gearbox. The first bull gear 20 of the first gearbox stage may mesh with these pinions to generate at least five first rotary outputs, which are transmitted via first output shafts 24 to a second gearbox stage 18.

In some cases, the first gearbox stage may have a gear ratio between, and including, 5:1 and 15:1. This range of gear ratios may provide flexibility in the design of the wind turbine gearbox 40, allowing for the optimization of the transmission of the wind-generated rotary input 12 to the electrical generators 14. The specific gear ratio of the first gearbox stage may be selected based on various factors, such as the desired speed of the generators 14, the amount of torque to be transmitted, and the specific requirements of the wind turbine system.

The second gearbox stage 18 may comprise a second bull gear 32 and second pinion gears 30 that mesh with the second bull gear 32 to generate second rotary outputs. These second rotary outputs are then transmitted to the generators 14 for generating electrical energy. In some aspects, the second gearbox stage 18 may have a gear ratio equal to or less than that of the first gearbox stage gear ratio, optimizing the transmission of the rotary outputs from the first stage to the electrical generators.

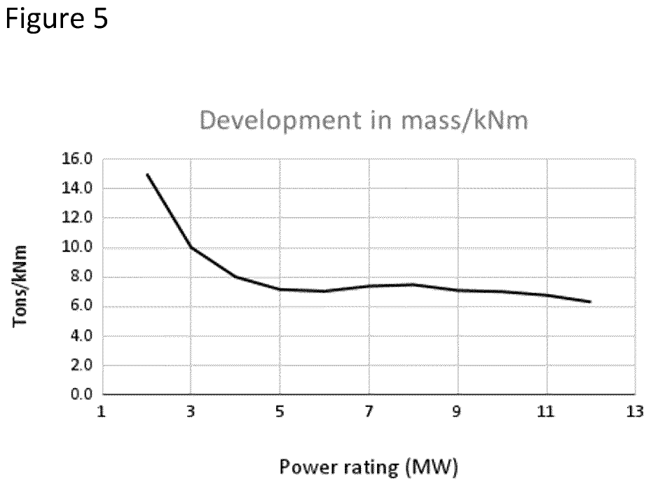

Referring to FIG. 5, a graphical representation is depicted, illustrating the development in mass per kilonewton-meter (kNm) as a function of power rating for wind turbine gearboxes. The horizontal axis of the graph may represent the power rating in megawatts (MW), while the vertical axis may show the mass in tons per kNm. In some aspects, the curve in the graph may indicate a trend where the mass per kNm of input torque decreases as the power rating increases. This decrease may be more pronounced at lower power ratings before stabilizing at higher power ratings. This trend may suggest that as the power rating of a wind turbine increases, the mass of the gearbox per unit of input torque may decrease, potentially leading to more efficient use of materials in the construction of the gearbox. In some cases, this trend may be used to guide the design and selection of gearboxes for wind turbines of different power ratings, potentially leading to more efficient and cost-effective wind turbine designs.

FIG. 5 illustrates typical values for development in mass (T) per kNm of input torque relative to power rating for planetary gearboxes used in wind turbines. The variation may be quite high for examples found in real world among different manufactures of gearboxes choosing different strategies in their design. The shown graph is considered the average of examples found. As seen, the mass of the gearboxes with respect to handled torque seems to be quite steady above 3 MW in power rating, whereas below 3 MW the mass increases significantly with respect to the handled torque.

The discovered relationship relates to the total mass of the gearbox with gearwheels, bearings and housing. There is a linearity between the mass of gearwheels and the torque handled. The previous conclusion was that at lower power ratings, the overall mass of the gearbox becomes determined by extra material/parts needed, which are not directly involved in torque transmission. Examples could be housing, attachment features or lubrication systems etc.

Embodiments of the invention comprise five pinions with associated generators. At powers below 3 MW, embodiments increase the bull-gear diameter to ensure proper space for supporting at least five generators. Thus, there is still a benefit to the embodiments but it is diminished.

In examples, the first gearbox stage has a first gear ratio and the second gearbox stage has a second gear ratio, and a total gear ratio (multiplum) of the first and the second gear ratios is 1:25 or more.

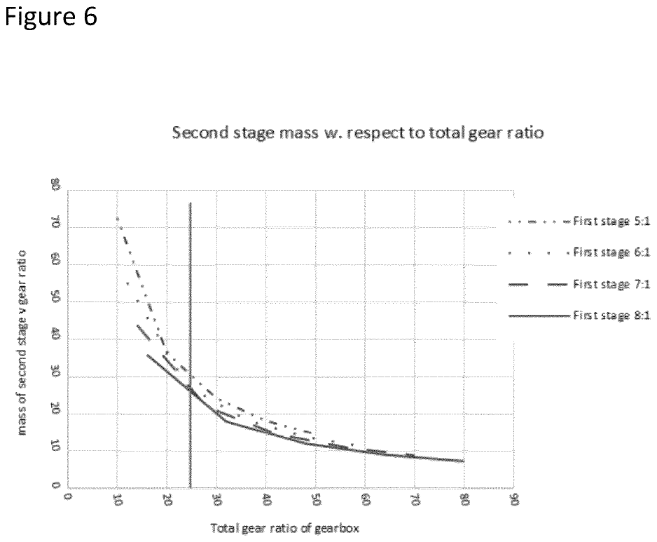

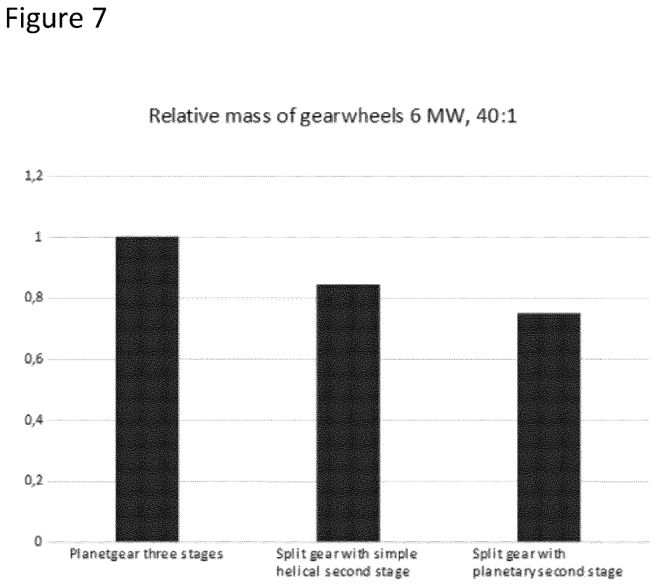

Turning to FIGS. 6 and 7, two graphs related to a wind turbine gearbox are depicted. FIG. 6 presents a line graph showing the relationship between the second stage mass of a gearbox and the total gear ratio for different first stage gear ratios. The graph compares four scenarios with first stage gear ratios of 5:1, 6:1, 7:1, and 8:1, illustrating how the mass of the second stage may vary with the total gear ratio of the gearbox. In some aspects, this relationship may be used to optimize the design of the gearbox, balancing the mass of the second stage with the desired total gear ratio to achieve efficient energy conversion.

FIG. 6 illustrates how the overall gear ratio relates to the relationship of the size of a second bull gear in the second gear stage. Thus, to create a high total gear ratio, the first gear stage gear ratio, and the second gear stage gear ratio must be multiplied. But, in order to handle the torque delivered by the first gear stage, the second bull gear has a certain size and weight. The lower the second gear ratio becomes, given a first gear ratio, the less the mass of the second gear ratio is utilized for increasing speed, as the main driver is the second bull gear and not the second pinion(s), which size to some extent determines the gear ratio of the second gearbox and the total gear ratio. So, when increasing the second gear ratio, the second bull gear does not change in size/mass, but is mainly determined by delivered torque from the first gear stage. Only the pinion(s) of the second gear stage is reduced. As there are in some embodiments only one pinion per driving gear wheel, the first bull gear wheel in the second gear stage, the mass/weight of the pinion becomes insignificant. As seen, in the illustration, given different first gear stage gear ratios, the cost in mass of having a second gear-stage becomes less with respect to gained higher gear ratio, as the overall gear-ratio exceeds 25:1. In the illustrated cases, there is an aspect ratio of bull gears of 10:1 in width/diameter, a common maximum load per width (2000 N/mm) and five pinions in the first gear stage to represent a viable solution.

In examples, the first gearbox of the first gearbox stage may be connected directly to a carrier of the rotational input, a wind turbine main shaft, or a wind turbine rotor. This configuration may allow for efficient transmission of the wind-generated rotary input to the gearbox stages. In some cases, the first gearbox stage may have a meshing teeth pattern that reduces the axial forces during load to less than 10% of the meshing forces acting during load, such as herring bone shaped helical gears that are angled to the circumference.

In planetary gears, the use of helical shaped teething patterns is widely used, to create smoother operation without undue noise. But, also the meshing is better, increasing the strength of the gearwheel. Normally, the helical shaping is made unidirectional, meaning the teeth are only helical angled in one direction. This is mainly due to easier manufacturing of the gearwheels, but in case of the planetary gear because the assembly of the annulus ring gear with the planets would be difficult if the helical shape had two different directions as seen and referred to as Herring bone pattern of the gearwheels, unless at least one gearwheel is assembled from two half-parts at the end of the assembly process.

The consequence of a planetary gear, having only single angled helical gear pattern, is that during meshing and transfer of power/forces, there will become an axial component of force trying to disengage the gear configuration. Thus, bearings must be chosen to transfer such axial forces and secure that the different components, sun wheel, planets, planet carrier is kept in places no matter the state of operation.

This is both more costly with respect to bearings, but also more troublesome with respect to avoiding the design complex, as most components must have bearings, for fixing their axial position and also radial position. In particular with respect to planetary gearboxes where many planets are used, this challenges the requirement for precision during manufacturing.

A preferable solution, in examples of embodiments of the invention, is that there is only outside toothing of the gearwheels, making manufacturing much easier with respect to the teething configuration (e.g. Herring-bone shaped teething—where teeth are helical with opposite angles). In addition, assembling such a gear, is facilitated as there is no annulus ring gear that would otherwise constrain design for meshing with both the bull and annulus gears the access to mesh gear wheels.

The main benefit from having herring bone shaped teeth pattern would be to eliminate or reduce the axial forces appearing during operation, in comparison to single helical pattern, where the axial forces easily increase significant with the angle of the Helical angle.

Such use simplifies the bearing design significantly, in particular the bearings used for the pinions, and allows for usage of plain bearings, in which the axial forces are only adapted with difficulties in such plain bearing designs.

Further, it is found that for very large wind turbines (above 3 MW) the gearwheels of the first stage may stay as simple spur gears, as the meshing of gearwheels happens at a lower rate, reducing generated noise, and simplifying the gearbox manufacturing. Just to serve as an example, the speed of such very large wind turbines may be as low as 0,2 s-1, meaning 5 seconds per rotation of the Bull gear. Given a large Bull gear may have 120 teeth, the number of teeth meshing per second is as low as 24 meshings/second. Apart from other aspects of the acoustics, such low number of meshing and expected very low ‘rumbling’—potentially off-shore, could eliminate the need for Helical shaped teething.

In embodiments of the invention, offsetting the meshing is chosen, meaning that all pinions are not in the same stage of their meshing sequence. Thus, the typical vibration and noise production may be suppressed. Having eight pinions, four pinions may be in the beginning of the one tooth going into carrying load, whereas the other four pinions will have teeth being in the middle of such sequence. Any combination may be chosen in order to minimize the noise progression.

According to previous figures and other examples, the second gearbox is of a planetary type, which reduces the overall size of the second stage gearbox, also reducing or limiting the usage of high-grade steel as a three planet gearbox will still become lighter when compared to a single pinion helical gear which is the another optional gear type for this stage.

In particular, when using the planetary gear-type for the second stage, in combination with the embodied first gear stage, a high reduction of high-grade steel is achieved. The usefulness of a planetary type of gearbox for the second stage is relevant as the second stage should hold the lowest gear ratio, and the first gear ratio the largest. Thus, for a particular gearbox having five pinions and 40:1 in total gear ratio, there is a reduction in mass of gearwheels and commensurate use of high-grade steel.

In examples, the first gearbox stage may be connected directly to a carrier of the rotational input, a wind turbine main shaft, or a wind turbine rotor. This configuration may allow for efficient transmission of the wind-generated rotary input to the gearbox stages. In some cases, the first gearbox stage may have a meshing teeth pattern that reduces the axial forces during load to less than 10% of the meshing forces acting during load, such as herring bone shaped helical gears that are angled to the circumference.

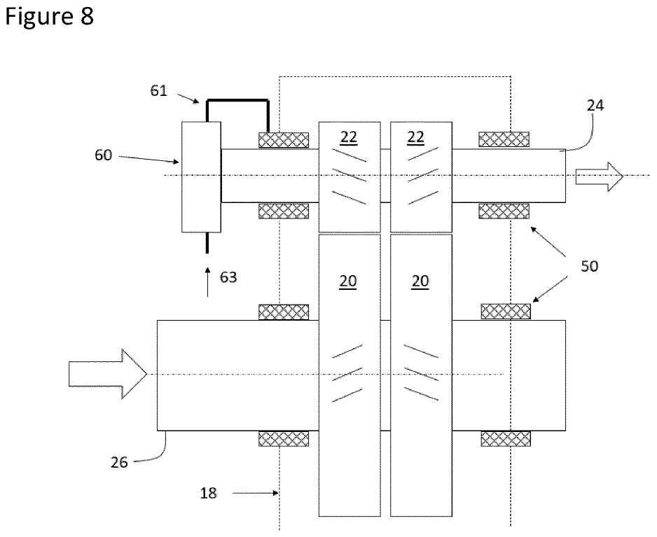

Referring to FIG. 8, a schematic representation of a component of a wind turbine gearbox is depicted. A bull gear 20 is centrally located and interlinked with an input shaft 26. The input shaft 26 is rotationally suspended within a frame or structure 18. In some aspects, the input shaft 26 may be connected directly to a carrier of the rotational input, a wind turbine main shaft, or a wind turbine rotor.

Pinion gearwheels 22 mesh with the bull gear 20 and are each rotationally supported by plain bearings 50. In some cases, the plain bearings 50 of the first output shafts may be of a hydrodynamic type. This configuration may enhance the durability and reliability of the gearbox operation. The pinion gearwheels 22 are connected to drive shafts 24, which are also supported by the plain bearings 50. In some embodiments, the pinion shafts of any of the first to third gearbox stages are connected to an oil pump 60. This configuration may facilitate the lubrication of the gearbox components, potentially enhancing the efficiency and longevity of the gearbox operation.

An oil pump 60 is driven by the drive shaft 24 of the pinion and is connected to the plain bearings 50 through internal channels 61, providing a pressurized flow of oil 63 to the bearings. In some aspects, the oil pump 60 may be external and driven by other means, such as electricity. In other cases, the oil pump 60 may be driven by the gearbox itself e. g in combination with the second or third output. This configuration illustrates the mechanical connections and lubrication system within the gearbox, potentially enhancing the efficiency and reliability of the gearbox operation.

The plain bearings of the pinions may be of any type including hydrodynamic or hydrostatic. Each of the bearings of the pinions may be lubricated by pressurized oil distributed from an oil pump 60, either external and driven by other means, such as electricity, or by an oil pump driven by the gearbox itself.

In embodiments of the invention the pump 60 is driven directly by the drive shaft 24 of the pinion and is integral or attachable e.g at one or more of the five pinion axles

In addition, the plain bearings may help adapting not only radial forces during operation of the gearbox, but also axial forces. Thus, the design may include tapered types of plain bearings, as well as plain bearings adapted for only radial adaption of forces or only axial. In particular, the usage of pressurized lubrication may support long lifetime of low speed rotating gear wheels.

The plain bearings may be made of different types of material, and may be containing bronze, copper, brass, aluminum be any kind of suitable alloy. Further the bearing may be of a polymer, but limited to PEEK, Nylon or Teflon.

The oil pump 60 may be connected to bearings 50, being hydrodynamic, hydrostatic or even roller type, through internal channels 61, providing a pressure and flow of oil 63. It should be understood that shifting from the usage of the ‘state of the art’ tapered roller bearings for pinion rotational fixation, to plain bearings of either hydrostatic or hydrodynamic type, decreases size and weight of the gearbox significantly. Having many pinions also requires as many bearings, and usually twice as many. Tapered roller bearings comprise both raceways and rollers of very high grade steel. Further to ensure that they may be commercial as a standard product, the raceways must have a significant sturdy design to ensure stability of the bearing during operation. Thus, typically such standard bearings become large and with a high weight. In particular in a planetary gearbox, the rotation of planets in a rotating planet carrier posses challenges for shifting to a plain bearing with a pressurized lubrication system. Though, the embodiments of the invention are much more prone by nature for such adaption of plain bearings, and in particular pressurized lubrication, which does not require rotational transfer of oil under pressure. If axial forces of pinions are eliminated, much simplicity is gained during assembly and manufacturing. In some embodiments of the invention, the mass of bearings for pinions may be reduced to 10% by the use of plain bearings instead of roller bearings. Further, the overall reduction in usage of high-grade steel may be lowered by 10% which comes in addition to the lowering of high grade steel used for gear wheels, by turning from the concept of a planet-gear towards embodiments of the invention.

Even though reliability of a gearbox may be positively compensated by additional extensive usage of additional high grade steel and even more extensive processing/quality assuring, reliability is also inherent in the mechanical concept or structure of the gearbox. Embodiments of the invention, disclosed, suggest both a reduction in usage of high grade steel/mass together with improved reliability, when comparing to the traditional planetary gearbox.

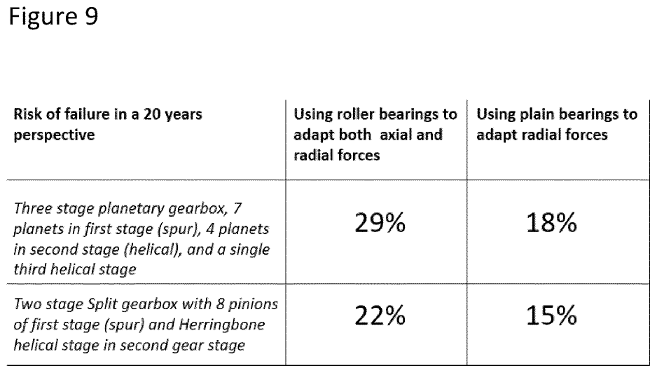

Referring to FIG. 9, a comparison of failure risks for different wind turbine gearbox configurations over a 20-year perspective is depicted. In some aspects, the configurations compared may include a three-stage planetary gearbox with a spur first stage and helical third stage, and a two-stage split gearbox with spur and Herringbone helical stages. The figure illustrates that the three-stage planetary gearbox may have a failure risk of 15%, which is the lowest among the compared configurations. This may suggest that the three-stage planetary gearbox could offer a higher reliability over a long-term operation period.

In some cases, the two-stage split gearbox may have a failure risk of 22%. This configuration may include a spur gear in the first stage and a Herringbone helical gear in the second stage. Despite the slightly higher failure risk compared to the three-stage planetary gearbox, the two-stage split gearbox may still offer a relatively high reliability in wind turbine applications.

In other aspects, the failure risk associated with the use of plain bearings in a radial configuration may be 18%. This suggests that the use of plain bearings in a radial configuration may provide a balance between reliability and performance in wind turbine gearbox applications.

On the other hand, the failure risk associated with the use of roller bearings may be the highest among the compared configurations, at 29%. Despite this higher failure risk, roller bearings may still be used in some wind turbine gearbox configurations, depending on the specific requirements and constraints of the application.

It is to be understood that the failure risks presented in FIG. 9 are illustrative and may vary depending on various factors, such as the specific design and configuration of the gearbox, the operating conditions, and the maintenance practices, among others. Therefore, the selection of a particular gearbox configuration and bearing type may be based on a comprehensive evaluation of these and other relevant factors.

In one aspect of the invention, it must be understood that a reduction in both size, weight and a higher reliability is only gained by using the split type gearbox, presented in embodiments of the invention, in combination with shifting to plain bearings. Such high gains would be difficult if not impossible to gain by replacing tapered roller bearings with plain bearings in a normal planetary gearbox.

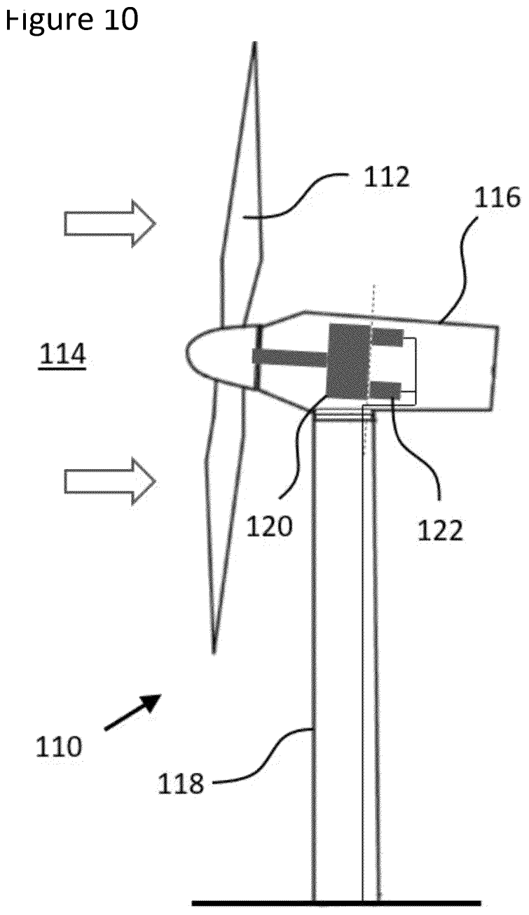

Referring to FIG. 10 there is a shown a wind turbine 110. The wind turbine comprises a plurality of turbine blades 112 that are mounted for rotation by wind 114 and are connected to a nacelle 116. The nacelle and the turbine blades are supported by a tower 118. The nacelle comprises a wind turbine gearbox 120 in accordance with the embodiments and description described above and as illustrated in relation to FIGS. 1 to 9. The gearbox arrangement receives wind generated energy and transmits it to a may be connected to a generator arrangement 122 that generates, which is configured to convert the mechanical energy received from the gearbox 120 into electrical energy for transfer to an electrical energy grid, national, regional or localized, to a home or community of homes.

Referring to FIG. 10, a side view of a wind turbine 110 is depicted. The wind turbine 110 may comprise a plurality of turbine blades 112 that are mounted for rotation by wind 114. The turbine blades 112 may be connected to a nacelle 116, which is positioned atop a support tower 118. The wind direction 114 is indicated by arrows, showing the flow of wind that the turbine blades 112 harness to generate energy. In some aspects, the turbine blades 112 may be designed and positioned to effectively capture wind energy from various wind directions 114.

Within the nacelle 116, a gearbox 120 may be present, which is responsible for converting the mechanical energy from the turbine blades 112 into a form suitable for electrical generation. In some cases, the gearbox 120 may comprise at least a first gearbox stage and a second gearbox stage, as described in relation to FIGS. 1 and 2 and may additionally including a third gearbox stage as described in relation to FIG. 3. The first gearbox stage may comprise a first bull gear that receives a wind generated rotary input. The first bull gear may mesh with at least five first pinion gears to generate at least five first rotary outputs. These first rotary outputs may be transmitted to a second gearbox stage, which may comprise any one or more gearbox type arrangements, such as a simple pinion/drive gear configuration, a planetary gear, or a split gear arrangement comprising an input gear.

In some embodiments, the first bull gear of the first gearbox stage may be connected directly to a carrier of the rotational input, a wind turbine main shaft, or a wind turbine rotor. This configuration may allow for efficient transmission of the wind-generated rotary input to the gearbox stages. In some cases, the first gearbox stage may have a meshing teeth pattern that reduces the axial forces during load to less than 10% of the meshing forces acting during load. This configuration may enhance the efficiency and reliability of the gearbox operation.

The gearbox 120 may be connected to a generator arrangement 122, which is configured to convert the mechanical energy received from the gearbox 120 into electrical energy. In some aspects, the generators 14 in the generator arrangement 122 may be AC generators having either a field winding or a permanent magnet. An electrically conductive coil may be located in the magnetic field, facilitating the conversion of the mechanical energy into electrical energy. This configuration allows for efficient energy conversion and adaptability to different wind turbine designs and operational conditions.

The support tower 118 provides the elevation for the turbine blades 112 to capture wind energy effectively. In some cases, the wind turbine 110 may further comprise a tower supporting the nacelle 116, and a plurality of turbine blades 112 mounted on the nacelle 116 for rotation by wind. This configuration may allow for efficient harnessing of wind energy for the generation of electrical energy.

A number of implementations have been described. Nevertheless, it will be understood that various modifications may be made without departing from the spirit and scope of the disclosure. Accordingly, other implementations are within the scope of the following claims.

1. A wind turbine gearbox for transmitting a wind generated rotary input to five or more electrical generators for generating electrical energy in a wind turbine, the wind turbine gearbox comprising:
at least a first gearbox stage comprising:
a first bull gear for receiving the wind generated rotary input;
at least five first pinion gears that mesh with the first bull gear for receiving the wind generated rotary input and generating at least five first rotary outputs;
and respective first output shafts fixed relative to the first pinion gears and suspended in plain bearings for rotation and transmitting to the five or more electrical generators the first rotary outputs via a second gearbox stage,
wherein the first gearbox stage has a gear ratio of 5:1 or more, and the second gearbox stage has a gear ratio equal to or less than that of the first gearbox stage gear ratio, and
wherein the pinion shafts of any of the gearbox stages are connected to an oil pump.

2. The wind turbine gearbox of claim 1, wherein the gear ratio of the second stage is less than or equal to 50% of the gear ratio of the first stage.

3. The wind turbine gearbox of claim 1, wherein the plain bearings of the first output shafts are of a hydrodynamic type.

4. The wind turbine gearbox of claim 1, wherein the first gearbox stage has a meshing teeth pattern that reduces the axial forces during load to less than 10% of the meshing forces acting during load.

5. The wind turbine gearbox of claim 1, wherein the second gearbox stage comprises a planetary gear type.

6. The wind turbine gearbox of claim 1, wherein the first bull gear of the first gearbox stage is connected directly to a carrier of the rotational input, a wind turbine main shaft, or a wind turbine rotor.

7. (canceled)

8. The wind turbine gearbox of claim 1, wherein the plain bearing is a hydrostatic type.

9. The wind turbine gearbox of claim 1, wherein the gear ratio of the first gearbox stage and the gear ratio of the second gearbox stage have a total gear ratio of 25:1 or higher.

10. The wind turbine gearbox of claim 1, wherein the second gearbox stage is an integral part of at least one generator providing a subassembly together with the at least one generator that is discrete from the first gearbox stage.

11. The wind turbine gearbox of claim 1, wherein the first gearbox stage has a meshing being a spur gear shape or a Herring bone shape, optionally by use of two bull gears with opposite helical angle.

12. The wind turbine gearbox as claimed in claim 1, wherein the second gearbox stage comprises a gear type comprising a single pinion driven gear meshing with a single driven gear.

13. The wind turbine gearbox of claim 1, wherein the second gearbox stage comprises a split gear type having 2 or more pinions per Bull gear.

14. The wind turbine gearbox of claim 1, wherein a pinion gear of the second stage and a driven gear of the second stage are fixed rotationally by plain bearings, optionally being hydrodynamic-or hydrostatic bearings, or any combination of that.

15. The wind turbine gearbox of claim 1, comprising a third gearbox stage and optionally further gearbox stages, and each of the third or further gearbox stages have a gear ratio of equal to or less than the gear ratio of the first gearbox stage.

16. The wind turbine gearbox of claim 1, wherein the first gearbox stage comprises between, and including, five and twelve pinions and has a gear ratio between, and including, 5:1 and 15:1.

17. The wind turbine gearbox of claim 1, wherein the oil pump generates a pressurized flow of oil.

18. A wind turbine nacelle comprising a wind turbine gearbox for transmitting a wind generated rotary input to five or more electrical generators for generating electrical energy in a wind turbine, the wind turbine gearbox comprising:
at least a first gearbox stage comprising:
a first bull gear for receiving the wind generated rotary input;
at least five first pinion gears that mesh with the first bull gear for receiving the wind generated rotary input and generating at least five first rotary outputs;
and respective first output shafts fixed relative to the first pinion gears and suspended in plain bearings for rotation and transmitting to the five or more electrical generators the first rotary outputs via a second gearbox stage,
wherein the first gearbox stage has a gear ratio of 5:1 or more, and the second gearbox stage has a gear ratio equal to or less than that of the first gearbox stage gear ratio, and
wherein the pinion shafts of any of the gearbox stages are connected to an oil pump.

19. The wind turbine nacelle of claim 18, wherein the gear ratio of the second stage is less than or equal to 50% of the gear ratio of the first stage.

20. The wind turbine nacelle of claim 18, wherein the plain bearings of the first output shafts are of a hydrodynamic type.

21. The wind turbine nacelle of claim 18, wherein the first gearbox stage has a meshing teeth pattern that reduces the axial forces during load to less than 10% of the meshing forces acting during load.

22. The wind turbine nacelle of claim 18, wherein the second gearbox stage comprises a planetary gear type.

23. The wind turbine nacelle of claim 18, wherein the first bull gear of the first gearbox stage is connected directly to a carrier of the rotational input, a wind turbine main shaft, or a wind turbine rotor.

24. (canceled)

25. A wind turbine comprising:
a nacelle, the nacelle comprising a wind turbine gearbox for transmitting a wind generated rotary input to five or more electrical generators for generating electrical energy in a wind turbine, the wind turbine gearbox comprising:
at least a first gearbox stage comprising:
a first bull gear for receiving the wind generated rotary input;
at least five first pinion gears that mesh with the first bull gear for receiving the wind generated rotary input and generating at least five first rotary outputs;
and respective first output shafts fixed relative to the first pinion gears and suspended in plain bearings for rotation and transmitting to the five or more electrical generators the first rotary outputs via a second gearbox stage,
wherein the first gearbox stage has a gear ratio of 5:1 or more, and the second gearbox stage has a gear ratio equal to or less than that of the first gearbox stage gear ratio, and
wherein the pinion shafts of any of the gearbox stages are connected to an oil pump.

26. The wind turbine of claim 25, wherein the first bull gear and the first pinion gears have a meshing teeth pattern that reduces the axial forces during load to less than 10% of the meshing forces acting during load.

27. The wind turbine of claim 25, wherein the second gearbox stage comprises a planetary gear type.

28. The wind turbine of claim 25, wherein the first bull gear of the first gearbox stage is connected directly to a carrier of the rotational input, a wind turbine main shaft, or a wind turbine rotor.

29. (canceled)

30. The wind turbine of claim 25, wherein the wind turbine further comprises a tower supporting the nacelle, and a plurality of turbine blades mounted on the nacelle for rotation by wind.
